(19) United States
(12) Patent Application Publication
(10) Pub. No.: US 2007/0239666 A1
(43) Pub. Date: Oct. 11, 2007

(54) Method and System for a De-Normalized Electronic-Catalog

(75) Inventor: James A. Garcia, Newark, CA (US)

Correspondence Address: AKERMAN SENTERFITT, P.O. BOX 3188, WEST PALM BEACH, FL, 33402-3188, US

(73) Assignee: Enporion, Inc., Tampa, FL (US)

(21) Appl. No.: 11/548,440

(22) Filed: Oct. 11, 2006

Related U.S. Application Data
(60) Provisional application No. 60/744,309, filed on Apr. 5, 2006.

(51) Int. Cl. G06F 17/30

(52) U.S. Cl. 707/2

(57) ABSTRACT

A system (100) and method (700) is provided for searching content in a de-normalized database. The method can include receiving (702) a search request from a user, constructing (703) a configuration query from a configuration table based on an identity of the user, and executing (704) a single fetch into a content table using the configuration query to retrieve content from the content table. The method can further include generating one or more threads for the one or more configuration queries, executing the one or more threads in parallel, distributing and redirecting the executing across one or more applications clusters, and presenting one or more query results to a common results table

### FIELD OF THE INVENTION

The present invention relates to database management systems and, more particularly, to methods for searching database systems.

### BACKGROUND

Database management systems are widely deployed for managing business to business e-commerce. As an example, supply chain management solutions in an e-commerce environment rely heavily on database management systems to give buyers and sellers access to online procurement transactions. Internet technology for supporting database management has also resulted in powerful and economical tools for supply chain professionals to improve supply chain performance. However, it is common for such database systems to employ computationally extensive searching methods. In particular, many database systems are based on relational database models that require access to numerous tables. The relational tables allow for powerful managing operations on vast quantities of data. However, the overhead involved with relational database management adversely affects search engine performance. The searches are generally conducted in accordance with the structure of the relational database system and result in decreased search performance.

As the number of buyers and sellers subscribing to an e-commerce system increases, the amount of data within the database increases. Consequently, a search for content within the databases can result in a longer wait time, thereby leading to customer dissatisfaction. A need therefore exists for increasing a search performance into a database while providing scalability.

### SUMMARY

Embodiments of the invention are directed to a method and system for searching a database. The system can include a de-normalized database having one or more supplier content tables, a configuration table for dynamically managing a content of the one or more supplier content tables, and a search engine for conducting a search into one or more categories of a supplier content table and retrieving content in a single fetch. A supplier configuration query can identify one or more categories in a supplier content table that are searched by the search engine. A user can enter a search request and the configuration table can generate one or more supplier configuration queries based on a customer identity and a customer view. A configuration query specifies a single fetch into the one or more supplier content tables. The configuration table can track a supplier, a view, and one or more price structures for the one or more supplier content tables to configure the content at a customer node level. The system can further include a data loader and scrubber for populating the configuration table, and a threading module for executing one or more configuration queries in parallel. The system can further include a load balancer for distributing and redirecting the executing across one or more applications clusters.

Embodiments of the invention are also directed to a method for searching content in a de-normalized database. The de-normalized database can include one or more content tables. The method can include receiving a search request from a user, constructing a configuration query from a configuration table based on an identity of the user, and executing a single fetch into the de-normalized database using the configuration query. In one arrangement, the configuration query can identify a search for one or more pricing structures in a content table based on an identity of the user. The method can further include determining a user view associated with the search request, and including the user view with the configuration query for narrowing a search in the content table. In one arrangement, a supplier configuration table can be created by determining a number of suppliers and buyers, and generating one or more supplier configuration queries based on the number of suppliers for each buyer.

The method of searching can further include generating one or more threads for the one or more supplier configuration queries, executing the one or more threads in parallel to produce one or more query results, and presenting the one or more query results to a common results table. The one or more query results can be presented and sorted in a common format in the common results table. The results can be displayed to a user. A loading of the threads can be balanced over one or more servers to provide scalability for hosting multiple products. The one or more threads can be executed independently in the one or more servers. The method can further include clustering common search requests to provide scalability for supporting multiple users.

Embodiments of the invention are also directed to a method for creating a configuration table. The method can include identifying at least one supplier associated with one or more content files, generating a supplier content table from the one or more content files, identifying a buyer of the supplies listed in the one or more content files, generating a supplier configuration that matches a pricing structure of the buyer in the supplier content table based on an identity of the buyer, and loading the supplier configuration in the supplier configuration table.

The method can further include determining one or more suppliers available to the buyer, generating a supplier content table for each additional supplier, generating a supplier configuration for each additional supplier based on the buyer's access to one or more pricing structures in the supplier content table, and updating the configuration table by loading the supplier configuration for each additional supplier into the supplier configuration table. The supplier configuration identifies which structures in a supplier content table are available to search by a buyer. Structures can be dynamically added to the content table for expanding a supplier offering. The method can further include determining a view associated with the buyer, and entering the view in a view structure in the supplier content table. The view can identify one or more entries in one or more structures of the supplier content table that are available for search to the buyer.

In one arrangement, a supplier content table can be generated by denormalizing a relational database model of the one or more content files to generate a column structured table, wherein the denormalizing includes converting one or more relational tables in the relational database model into columns in the column structured table, wherein the one or more relational tables represent the one or more content files. As an example, a supplier configuration can be a column formatted table having a content column, a price column, or a view column, wherein the columns are the structures of the supplier content table.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a diagram of an e-catalog system 100 for providing user scalability and product scalability in accordance with the embodiments of the invention;

FIG. 2 is a diagram of a content table in accordance with the embodiments of the invention;

FIG. 3 is a diagram presenting one or more views in accordance with the embodiments of the invention;

FIG. 3 is a diagram of a configuration table in accordance with the embodiments of the invention;

FIG. 4 is an illustration of a buyer and supplier layout in accordance with the embodiments of the invention;

FIG. 5 is a method for creating a configuration table in accordance with the embodiments of the invention;

FIG. 6 is a method for searching a de-normalized database in accordance with the embodiments of the invention;

FIG. 7 is a schematic of a configuration query in accordance with the embodiments of the invention;

FIG. 8 is a schematic of a threaded and parallel computing architecture in accordance with the embodiments of the invention;

FIG. 9 is a schematic for load balancing in accordance with the embodiments of the invention; and

FIG. 10 is a schematic for application clustering in accordance with the embodiments of the invention.

FIG. 11 is a schematic for IP load balancing in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” can be defined as any number of suitable processors, controllers, units, or the like that are capable of carrying out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Embodiments of the invention are directed to an electronic catalog (e-catalog) system for facilitating a rapid search into a de-normalized database. In particular, content can be searched with a single fetch. The e-catalog allows a large number of organizations and departments to provide custom and configurable searches into a large number of content databases. For example, the e-catalog system can be integrated within a multi-vendor environment for supporting an on-line buyer and supplier market. In one application, the e-catalog system allows buyers to conduct rapid searches into one or more supplier tables for identifying one or more supplies available to the buyer. A purchasing relationship between the buyer and the supplier can determine what supplies are available to the buyers and the pricing structures associated with the supplies. Pricing structures can be transparently included within a configuration table of the e-catalog to identify buyer pricing arrangements. Suppliers can also update the one or more supplier tables to include additional supplies and update the pricing structures.

The e-catalog system can provide high scalability in both the number of users and the number of products. The e-catalog can support content from various suppliers and buyers from multiple selling and purchasing organizations. In one arrangement, the e-catalog system can provide supply chain management services that increase the efficiency of business transactions. For example, the e-catalog system can assist buyers and suppliers in reducing lifecycle costs of goods and services through both price and process savings. The e-catalog system can provide underlying functionality for an on-line commerce environment for conducting buyer and supplier electronic transactions. As one example, on-line commerce environment can enable and support supplier connections and provide a full scope of supply chain support from sourcing to invoicing and payment.

Specifically, the e-catalog system can include a configuration table that manages a search into a de-normalized database. The configuration table provides custom configurations that allow a user to search content tables of one or more suppliers with a single fetch of a configuration query. The content tables are arranged in a structured format that allows for the generation of a single configuration query. As one example, a configuration query identifies which content tables can be searched based on an identity of the user. A configuration query can be generated from the configuration table and supplied to a search engine to search for content in one or more content tables in a single fetch. The content tables are highly de-normalized and are managed by the configuration table. Moreover, structures can be dynamically added to the content tables to expand content.

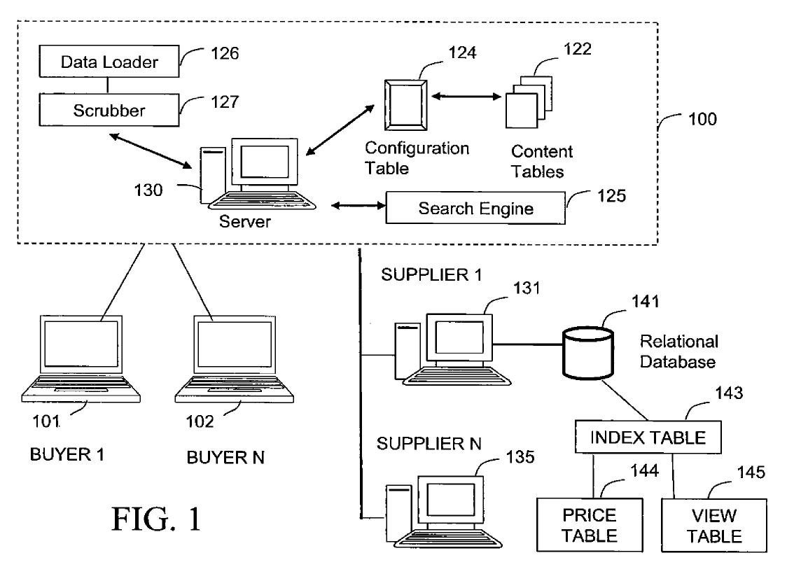

Referring to FIG. 1, an e-catalog system 100 for providing user scalability and product scalability is shown. The e-catalog system 100 supports content management and distribution for multiple users. The e-catalog system 100 can include a search engine 125 for searching one or more search words, a configuration table 124 for identifying one or more search configurations into one or more content tables 122. The e-catalog system 100 can also include a data loader 126 for loading configurations in the configuration table 124, and a data scrubber 127 for preparing data in the content tables 122. In one arrangement, the search engine 125, configuration table 124, content tables 122, data loader 126, data scrubber 127, can be hosted on the server 130.

The e-catalog system 100 can be deployed within a buyer and supplier e-commerce marketplace to facilitate buyer and supplier business-to-business transactions. The e-catalog system 100 can be deployed within an intranet, an extranet, the Internet, or any other suitable communication setting for providing connected or on-line e-commerce. As one example, the e-catalog system 100 can provide connection to one or more buyer and supplier networks for receiving purchase request information and product information. For example, the server 130 can establish data communication with one or more suppliers, 131 and 135, and one or more buyers, 101 and 102. The server 130 may host supplier information locally on the server 130, or through a remote connection to the supplier. In the foregoing description, buyers and suppliers will be referred to as entities which provide communication. For example, Buyer 1 can be laptop 101 and Supplier 1 can be server 131, but is not limited to this arrangement.

Briefly, the configuration table 124 specifies categories within the content tables 122 that are presented within a configuration query to the search engine 125. The search engine 125 can be a full-text search engine or a relational database search engine contained within the server 130. Alternatively, the search engine 125 may be on a remote server or in a distributed network. The search engine 125 can search data specific to categories of the content tables 122 for responding to a search request. In particular, the configuration table 124 can produce a configuration query in response to a buyer's search request based on configurations within the configuration table 124. A configuration can define an availability or access to products between one or more buyers and one or more suppliers. The configuration query can be used as a single fetch to the search engine 130 to narrow the field of search and reduce a number of search requests within the server 130. In one arrangement, the configuration table 124 can incorporate buyer and supplier relationship information for determining which products listed by one or more suppliers are available to a buyer.

In practice, it is common for suppliers to utilize relational databases. Relational databases and relational database searches are known in the art. A relational database is a database structured in accordance with a relational model. For example, Supplier 131 may have a relational database 141 containing one or more relational tables having a relation specified by an index table. For example, the index table 143 identifies a relationship of data between the price table 144 and the view table 145. The price table 144 may identify prices of one or more supplies, and the view table 145 may identify the prices a buyer sees for those supplies. Accordingly, extracting data from the relational database generally involves accessing more than one relational table. For example, in order to fulfill a search request on a specific product, Supplier 131 accesses the index table 143 to determine which price tables 144 and view tables 145 correspond to the product. In this case, the search takes 3 fetches into each table for responding to a search request.

The number of fetches into the relational database 141 can be reduced by de-normalizing the relational database. One aspect of the invention, is a method of de-normalizing a database. Data normalization is the process of defining common descriptions and attributes for the same or similar products, for example, those products offered by different suppliers. Within the context of a relational database model, normalization refers to the overhead associated with the relating of one or more relational tables. Accordingly, data de-normalization is the process of removing the overhead associated with relational models, and placing the data of the one or more related tables into a single table. The single table contains all the data from the one or more relational tables. However, a de-normalized data model requires data configuration management to manage content within the single table. The content refers to the data within the single table and can include product description information, view information, and pricing information.

In order to reduce the number of fetches performed by a supplier into a relational database, the server 130 de-normalizes the data to one or more supplier relational databases. The server 130 can store the de-normalized data in a supplier content tables 122 which can be accessed in response to a search request. The supplier content tables 122 can be stored at the server 130 or the Supplier server 131. The server 130 can de-normalize supplier relational databases for more than one Supplier to produce one or more content tables 122, herein called supplier content tables. In principle, a supplier content table 124 can be generated for each supplier. It should be noted that the supplier content tables 122 refers to a collection of supplier content tables and not just one table. It should also be noted, that data from a supplier can be entered in a de-normalized format. The de-normalization process of the server 130 is not restricted to de-normalizing only relational databases. Notably, a supplier content table 122 can be generated from tables other than relational tables.

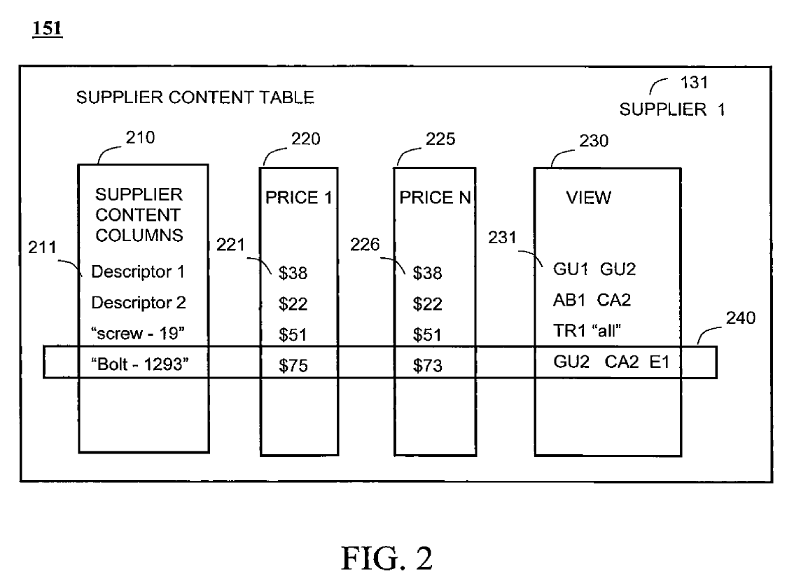

Referring to FIG. 2, an exemplary supplier content table 151 for Supplier 1 (131) is shown. The supplier content table 151 can be one table in the supplier content tables 122 of FIG. 1 and is not limited to the structured arrangement shown. The supplier content table 151 lists one or more products of Supplier 1 by category. The supplier content table 151 can include one or more categories for describing the products, such as a supplier content structure 210, one or more price structures 220 and 225, and a view structure 230. The categories include content from one or more de-normalized relational tables. The supplier content structure 210 can provide a textual description 211 of the one or more products. For example, the description can identify a Stock Keeping Unit (SKU), a manufacturing number, a serial number, a short description of the product or a long description of the product, or any other suitable descriptor. The pricing structures 220 and 225 identify prices for the products. More than one pricing structure can be included in the supplier content table 151. For example, a supplier may want to provide a first set of prices 211 for a contracted buyer and a second set of prices 226 for a non-contracted buyer. In one arrangement, each row within the supplier content table can correspond to a record. For example, a buyer searching for parts in the supplier content table 151 of Supplier 1 (131) may specify a request for a bolt. Record 240 identifies a bolt having a SKU number 1293 with a price of $75 for Price 1, and a price of $73 for Price 2, which is available to buyers either having a GU2 or CA2 view. The view structure 230 identifies which products are available through certain views. For example, a supplier may provide supplies for multiple departments of an organization. Each department can be assigned a view number to screen for those products applicable to the department. The view number 231 identifies which departments, or users, have access to the products in the supply content table.

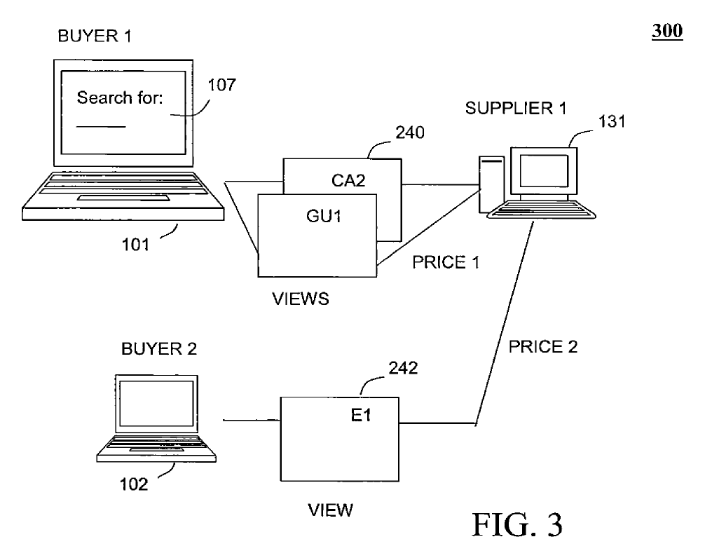

Referring to FIG. 3, a supplier view 300 is shown. The supplier view 300 corresponds to a visual interpretation of record 240 in the view column 230. In this exemplary view, Supplier 1 (131) can have a first Buyer 101 and a second Buyer 102. Supplier 1 provides a first set of views 240 to Buyer 1 (101) and a second set of views 242 to Buyer 2 (102). For example, Supplier 1 may be an automotive parts provider having a various parts or services for sale. Buyer 1 may be a repair store having a service department and a sales department. Accordingly, Buyer 1 and Supplier 1 can decide on a view (GU2) for the service department and a view (CA2) for the sales department. The view determines which products the departments have access to view. When an individual from the service department logs onto the e-catalog system 100 (See FIG. 1), view GU2 is presented to the user. In this view, the individual can select those products available through view GU2. A price structure can be assigned to the Buyer. For example, Price 1 (220) can be assigned to Buyer 1 and Price 2 (225) to Buyer 2. the price structure identifies the price of the products which may or may not be dependent on the view.

A user input module 107 allows the buyer to enter in a search request for a product. In one arrangement, the user input module can be a web page or intranet site hosted by the server 130 (See FIG. 1). The user input module 107 can determine an identify of the buyer. For example, the laptop 101 can be assigned a fixed Internet Protocol (IP) address that is associated with a service department or a sales department. The user input module or the server can identify the buyer based on the IP address and assign a view based on the identity. The view presents those items available for purchase or procurement to the buyer using the laptop. Understandably, the laptop is presented as an example for identifying a user. Other means for identifying a user are herein contemplated. For example, a login screen having a login name and password can identify a buyer. Similarly, when a user from the sales department logs on to the e-catalog system, those items particular to the view are presented to the user. Understandably, Supplier 1 can customize content through the views to the one or more buyers. Notably, Supplier 1 may have an entirely different set of views for Buyer 2, based on a purchasing relationship or contract established with Buyer 2. In addition, a pricing structure for Buyer 2 may be different than that for Buyer 1.

Referring, back to FIG. 2, the supplier content 210, price 220, and view 230 categories can be represented as row or column structures in the supplier content table. The structures are represented as columns but are not limited to this arrangement. The column format suggests one embodiment for the supplier content table and is presented merely for illustration; e.g. the structures can be arranged as rows. Understandably, each supplier can have more or less than the number of columns shown in a supplier content table 151. For example, Supplier 1 may have 4 pricing columns, whereas Supplier 2 may have 7 pricing columns. The pricing columns determine the prices to associate with the products. Understandably, Suppliers may provide more than one set of pricing structures for their products. In addition, the length of the columns of each category depends on the number of products listed by the supplier. Accordingly, the length of the columns may not be fixed for different suppliers. Consequently, the structure of a supplier content table is dependent on the Supplier, and can vary between suppliers. Moreover, content can be selectively added or removed from the supplier tables by the suppliers. For example, a supplier may list new products and update views or product descriptions. Understandably, the supplier content tables can vary in size. Briefly referring back to FIG. 1, the e-catalog system 100 can manage the supplier content tables for the one or more suppliers. In particular, the configuration tables 124 allow for dynamic adjustment to the supplier tables in accordance with newly provided supplier information. That is, the e-catalog system 100 can update the supplier content tables 122 and the configuration table 124 to allow updated searches into the supplier content tables 122. For example, additional price columns can be added to a particular supplier content table, and information regarding the new columns can be included in the configuration table 124. Again, the configuration tables 124 define which categories to search, for example, based on a buyer and supplier relationship.

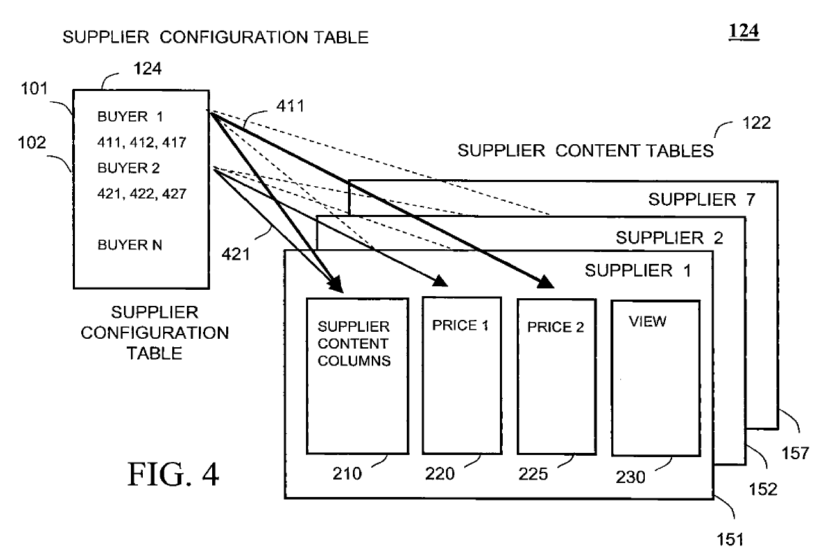

Referring to FIG. 4 an exemplary configuration table 124 is shown in greater detail. Notably, embodiments of the invention are directed to using a configuration table and one or more content tables for coordinating buyer and supplier business transactions as an application example. Understandably, the configuration table 124 is not limited to buyer and supplier transactions and can be used for general database access. For example, the e-catalog system 100 of FIG. 1 can be used to manage business reporting, financial records, accounting records, medical records, and the like.

In the particular example of FIG. 4, the configuration table 124 can manage a number, N, of supplier content tables 122 for N Suppliers. The configuration table 124 consists of a list of configurations specific to one or more buyers. One or more configurations can be provided to each buyer in the configuration table 124. For example, Buyer 1 may have a configuration 411 into supplier content table 151. Buyer 1 may also have a configuration into supplier content table 152 and 157. Buyer 1 can have a configuration for each supplier available to Buyer 1. For example, Buyer 1 can have a configuration for Supplier 1 (151), a configuration for Supplier 2 (152), and a configuration for Supplier 7 (157) as shown in FIG. 4.

A configuration identifies categories within the supplier content table that are specific to a particular buyer. Recall, each supplier can have a supplier content table. Each configuration in the configuration table identifies those categories that are specific to a buyer. In particular, the configuration defines which categories are available for search in a supplier content table. For example, configuration 411 (i.e. arrows in FIG. 4) is specific to Buyer 1 in with regard to Supplier 1. Configuration 411 reveals that Buyer 1 has access to the supplier content column 210 and the Price 2 (225) column of Supplier 1 (131). Similarly, configuration 421 is specific to Buyer 2 with regard to Supplier 1, and reveals that Buyer 2 has access to the supplier content column 210 and the Price 1 (220) column of Supplier 1 (131). Notably, the price structure of Supplier 1 is different for configuration 411 and 421. That is, Buyer 1 and Buyer 2 may have access to the same supplies provided by Supplier 1, though the pricing of the supplies is different. Notably, each buyer in the configuration table has a number of configurations that are equal to the number of suppliers available to that buyer.

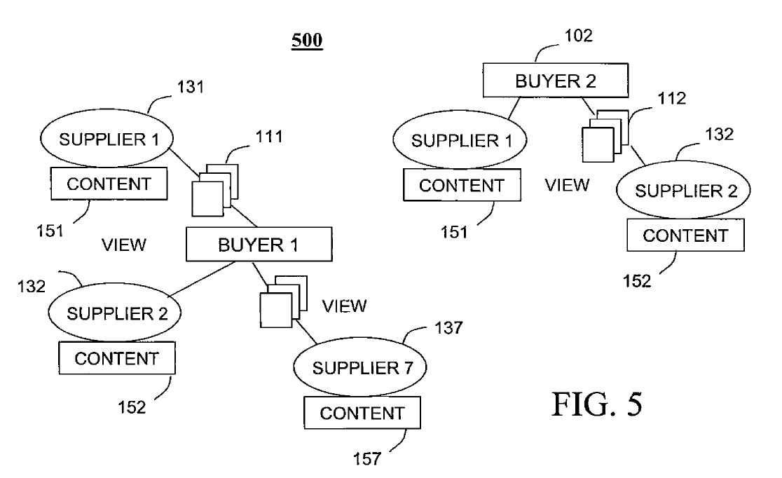

Referring to FIG. 5, an exemplary buyer and supplier layout 500 is shown. The layout 500 identifies relationships between one or more buyers and one or more suppliers. For example, Buyer 1 can have a purchasing relationship with 3 suppliers that each have a corresponding supplier content table: Supplier 1 (131) having content table 151, Supplier 2 (132) having content table 152, and Supplier 7 (137) having content table 157. Recall, the content table is a de-normalized data structure that is managed by the configuration table 124. Accordingly, 3 configurations are provided for Buyer 1 in the configuration table 124 of FIG. 4. That is, a configuration is provided for each supplier content table. Understandably, each buyer can have purchasing relationships with more or less than the number of suppliers shown. As another example, Buyer 2 may have 2 suppliers and hence 2 configurations are provided in the configuration table 124. In fact, Buyer 2 may have purchasing relationships with the same suppliers of Buyer 1.

Understandably, the configuration table 124 keeps track of the purchasing relationships between one or more buyers and one or more suppliers. Referring back to FIG. 4, the configuration table 124 can track a supplier content column 210, one or more price structures 210-225, and a view for one or more supplier content tables 122. The configuration table 124 can perform this management of multiple suppliers for one or more buyers. This allows the e-catalog system (100) to configure buyer content at a customer node level. Each buyer can have one or more suppliers that can provide products or services to the buyer. The buyer may have a contractual arrangement with the supplier to purchase products at a certain price. Similarly, the supplier may have contractual arrangement with other buyers for purchasing prices at another price. This buying and supplier relationship can be provided to the e-catalog system (100) prior to creating the configuration table 124. Accordingly, the configuration table 124 captures the buyer and supplier relationship through the one or more configurations in the configuration table 124.

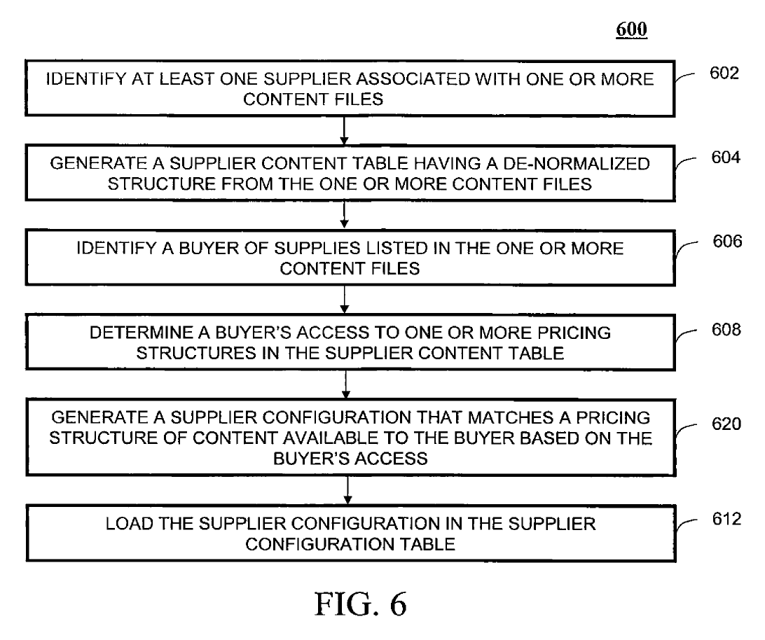

Referring to FIG. 6, a method 600 for creating a configuration table 124 is shown. The method 600 can be practiced with more or less that the number of steps shown. To describe the method 600, reference will be made to FIGS. 1, 3, 4, and 5 although it is understood that the method 600 can be implemented in any other suitable device or system using other suitable components. Moreover, the method 600 is not limited to the order in which the steps are listed in the method 600 In addition, the method 600 can contain a greater or a fewer number of steps than those shown in FIG. 6.

A first part of the method 600 involves identifying suppliers. At step 602, at least one supplier associated with one or more content files can be identified, wherein the content files describe supplies provided by the at least one supplier. For example, referring to FIG. 5, a buyer may solicit one or more suppliers (131-137) to register their products with the e-catalog system 100. The supplier may provide content files (151-157) to the e-catalog system 100 that are organized in a relational table format. At step 604, a supplier content table can be generated from the one or more content files. For example, referring to FIG. 5, if the content tables (151-157) are in a relational database format, a processing system, such as server 130 (See FIG. 1), can convert the relational tables to a de-normalized structure. For example, a relational database model having one or more content files can be de-normalized to generate a column structured table as shown in FIG. 4. The de-normalization may include converting one or more relational tables in the relational database model into columns in a column structured table, such as the supplier content table of FIG. 4. If the content tables are not in a relational database format they can be arranged in a structured format complying with categories of the supplier content tables. Notably, the supplier content table 151 in FIG. 4 is de-normalized in comparison to the relational tables 143, 144, and 145 in FIG. 1.

A second part of the method 600 involves identifying buyers. At step 606, a buyer of the supplies listed in the one or more content files can be identified. For example, a buyer may register with the e-catalog system 100 on-line or through contracts. Alternatively, a supplier may provide registration information for one or more of their buyers. At step 608, a buyer's access to one or more pricing structures in the supplier content table can be determined. Pricing information, or access to products, is generally provided by the Supplier and is made available to the e-catalog system 100. For example, a supplier will provide pricing information and access information pertaining to one or more buyers. Given this information, at step 610, a supplier configuration can be generated for each buyer. The supplier configuration matches a pricing structure to the content in the supplier content table. That is, the pricing structure identifies products that are available to the buyer for search based on the buyer's access. The buyer's access can be determined by the buyer's identity. For example, as discussed in FIG. 3, a buyer's identity can be determined in one of many ways.

The supplier configuration corresponds to the description of the configuration discussed in FIG. 5. That is, a supplier configuration is assigned to each buyer based on structures established by the buyer's suppliers; for example, pricing structures. The supplier configuration 411 (see FIG. 4) identifies which categories in the supplier content tables 151 can be searched for content. At step 612, the supplier configuration can be loaded in the supplier configuration table. Referring to FIG. 5, each buyer will have a supplier configuration that is unique to one or more of the buyer's Suppliers. For example, Buyer 1 has configuration 411 for Supplier 1, and a configuration for both Supplier 2 and Supplier 7. Buyer 2 has configuration 421 for Supplier 1, and also a configuration for both Supplier 2 and Supplier 7. The supplier configurations identify which categories in a supplier content table are available for search by the Buyer.

Notably the steps of creating a supplier configuration include determining one or more suppliers available to the buyer, generating a supplier content table for each additional supplier, generating a supplier configuration for each additional supplier based on the buyer's access to one or more pricing structures in the supplier content table, and updating the configuration table by loading the supplier configuration for each additional supplier into the configuration table (124). The supplier content tables (122) can be dynamically expanded to include new product offerings. Accordingly, the configuration table (124) can keep track of the new product offerings as a result of the updated supplier content tables. For example, referring back to FIG. 4, the data loader 126 and scrubber 127 can add additional configurations to the configuration table 124 for each buyer as Suppliers update their product offerings. Further, the scrubber can remove or redefine categories and provide cross checks with data in the supplier content tables. Given the arrangement of the supplier content table shown in FIG. 4, new columns can be added to expand the product offering. In addition, the lengths of the columns can dynamically increase or decrease based on Supplier updates.

The method 600 can further include determining a view associated with the buyer, and entering the view in a view structure in the supplier content table. The view (See FIG. 3) identifies one or more entries in one or more categorical structures of the supplier content table that are available to the buyer. Each view can be given a unique identifier such as “GU2” or “CA2”. During a loading of a configuration into the configuration table 124 (See FIG. 4), the unique identifiers can be separated by a space to allow stemming of the view identifiers in the full text search engine 125 (See FIG. 1). This allows the e-catalog to take advantage of the full-text search engine's efficiencies. It also allows views to be created down to the SKU level.

Notably, the method 600 for creating a configuration table is a first step for performing a search query. Upon creating the configuration table 124, a buyer can search into one or more supplier content tables based on one or more configurations in the configuration table 124. Consequently, the e-catalog system 100 provides a rapid search based on one or more configurations which are specific to a buyer.

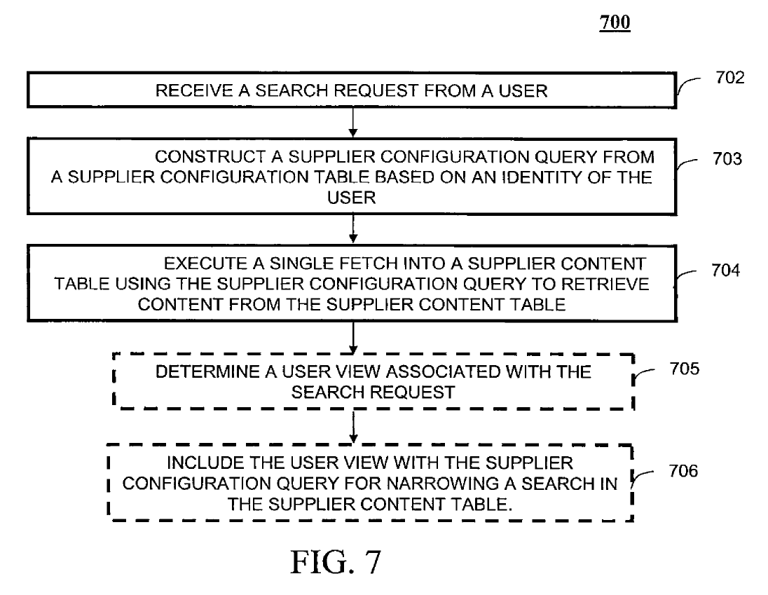

Referring to FIG. 7, a method 700 for searching content in a de-normalized database is shown. The method 700 can be practiced with more or less that the number of steps shown. To describe the method 700, reference will be made to FIGS. 1, 2, 3, 4, 5, and 8, although it is understood that the method 700 can be implemented in any other suitable device or system using other suitable components. Moreover, the method 700 is not limited to the order in which the steps are listed in the method 700 In addition, the method 600 can contain a greater or a fewer number of steps than those shown in FIG. 7.

At step 702, a search request can be received from a user. For example, referring back to FIG. 2, a buyer can enter a search request into a user input module 107 on the laptop 101. The laptop 101 can provide a user input module which establishes a connection with the server 130. In one arrangement, the server 130 can host web pages that allow a buyer to login to the e-catalog system 100. The e-catalog system 100 can determine an identify of the user based on a login, though other means are herein contemplated for identifying the user as previously discussed. The user input module can capture a search request. For example, the user can enter a search for a “bolt”.

At step 704, a supplier configuration query can be constructed from a configuration table based on an identity of the user and the search request. A supplier configuration query can be a select statement that is submitted to a full text search engine. For example, referring back to FIG. 1, the search engine 125 can perform a search for text or data in the one or more supplier tables 122 based on the select statement. Understandably, a full-text search on the search request “bolt” could result in many matches from the various suppliers. A scope of the search can be narrowed by limiting the search to those suppliers available to the buyer. Moreover, embodiments of the invention are directed to the generation of a supplier configuration query that results in a single fetch into a supplier content table.

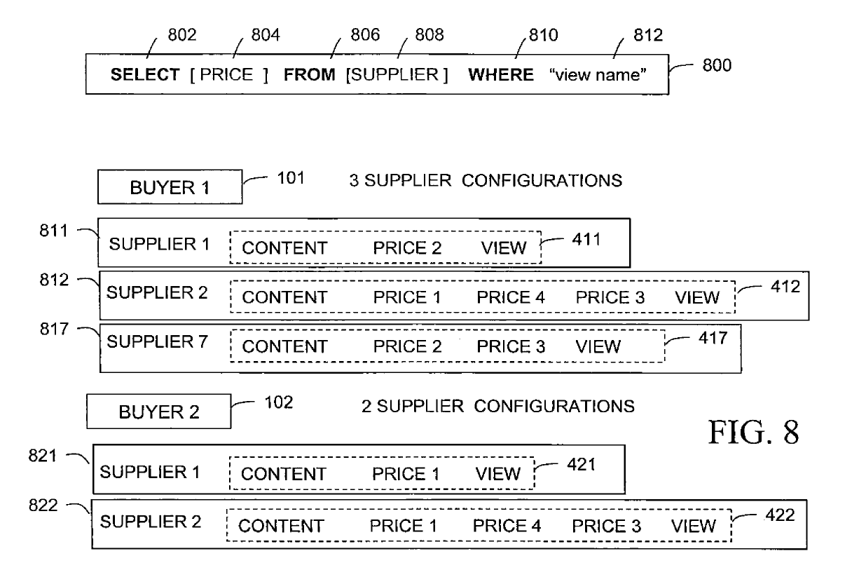

An exemplary supplier configuration query 800 (e.g. select statement) is shown in FIG. 8. The supplier configuration query 800 can consist of a SELECT statement 802, a FROM statement 806, and a WHERE statement 810. The supplier configuration query is a standard select statement for querying a database as is known in the art. However, the construction and generation of the select statement for providing a single fetch search based on the configuration table 124 and content tables 122 is unique to the invention. In particular, the parameters of the supplier configuration query 800 are supplied by the configuration table 124 of FIG. 4 which specifies a configuration for the supplier configuration query. For example, the SELECT parameter “price 2” 804 is generated by a supplier configuration, the FROM parameter “SUPPLIER 1” 808 is generated by the supplier configuration, and the WHERE parameter “view name” is generated by the supplier configuration.

For illustration, two sets of supplier configurations are shown; one set for Buyer 1 (101), and one set for Buyer 2 (102). The supplier configurations correspond to the configurations shown for Buyer 1 and Buyer 2 in FIG. 4 and the buyer and supplier relations shown in layout 500 of FIG. 5. As shown in FIG. 5, Buyer 1 can have access to suppliers 131, 132, and 137 each having a separate configuration 411, 412, and 417 (see configuration table 124 of FIG. 4), respectively. For example, configuration 411 identifies Buyer 1 as having access to content, price 2, and view columns in supplier content table 151 for Supplier 1 (131) (See FIG. 4). Configuration 412 identifies Buyer 1 as having access to content, price 1, price 4, price 3, and view columns in supplier content table 152 for Supplier 2 (132). Configuration 417 (See FIG. 8) identifies Buyer 1 as also having access to content, price 2, price 3, and view columns in supplier content table 157 for Supplier 7 (137). The configurations 411, 412, and 417 identify what categories in the respective supplier content tables are available for searching. Notably, a supplier configuration query is generated from a supplier configuration. For example, Buyer 1 (101) will have 3 supplier configuration queries 811, 812, and 817, corresponding to searches for products listed by Suppliers 131, 132, and 137, respectively. The supplier configuration query identifies the Supplier and the categories available for search by Buyer 1. For example, the first supplier configuration query 811 for Buyer 1 will be of the form:

SELECT [price 2] FROM [SUPPLIER 1] WHERE [view name] [token]

where “view name” may be a unique identifier based on an identify of the buyer, and token is the search word provided in a search request. For example, referring back to FIG. 7, at step 706, a user view associated with the search request can be determined. At step 708, the user view can be included with the supplier configuration query for narrowing a search in the supplier content table. For example, the view name may be “GU1” or “CA2”, and the token may be the word “bolt”. The select statement (i.e. supplier configuration query) can be provided to the search engine 125 (See FIG. 1) as a single fetch statement. The select statement informs the search engine 125 that a search for the key word “bolt” is to be conducted in the content table 151 of SUPPLIER 1, for products corresponding to price 2 and within a view specified by “view name”. Notably, only a single fetch into a single supplier content table (151) of a de-normalized database is commissioned. The select statement limits a scope of the search to a single supplier table. Upon completion, of the supplier configuration query for Supplier 1, another select statement can be generated for querying Supplier 2. For example, the second supplier configuration query 812 for Buyer 1 will be of the form:

SELECT [price 1,3,4] FROM [SUPPLIER 2] WHERE [view name] [token]

The second select statement (i.e. supplier configuration query) can be provided to the search engine 125 (See FIG. 1) as a single fetch statement. The select statement informs the search engine 125 that a search for the key word “bolt” is to be conducted in the content table 152 of SUPPLIER 2, for products corresponding to price 1, 3, and 4, and within a view specified by “view name”. Notably, only a single fetch into a single supplier content table of a de-normalized database (152) is commissioned. Similarly, the third supplier configuration query 817 will consist of buyer specific information contained in configuration 417 and Supplier 7 content table 157.

Similarly, Buyer 2 (102) has two supplier configuration queries 821 and 822 corresponding to configurations 421 and 422 based on the relationships shown in layout 500 of FIG. 5. Configuration 421 identifies Buyer 2 as having access to content, price 1, and view columns in supplier content table 151 for Supplier 1 (131). Configuration 422 identifies Buyer 2 as having access to content, price 1, price 4, price 3, and view columns in supplier content table 152 for Supplier 2 (132). Notably, the structures (content, price, view) in the configurations list one or more products. For example, referring back to FIG. 4, the content column 210 includes descriptions for each product listed by Supplier 1. The price 1 column 220 includes prices for each product listed by Supplier 1. Accordingly, the supplier configuration identifies which categories in a supplier content table can be searched for content by a particular buyer. For example, the supplier configuration query can identifies one or more pricing structures in the configuration table that are searched based on the identity of the user. Supplier configuration queries can be generated for Buyer 2 similarly to the select statements presented for Buyer 1. Accordingly, the server 125 can issue a single fetch into a de-normalized database (i.e. content tables 122) to retrieve content from a supplier content table. Notably, the search engine 125 handles the view and content identification in a single query.

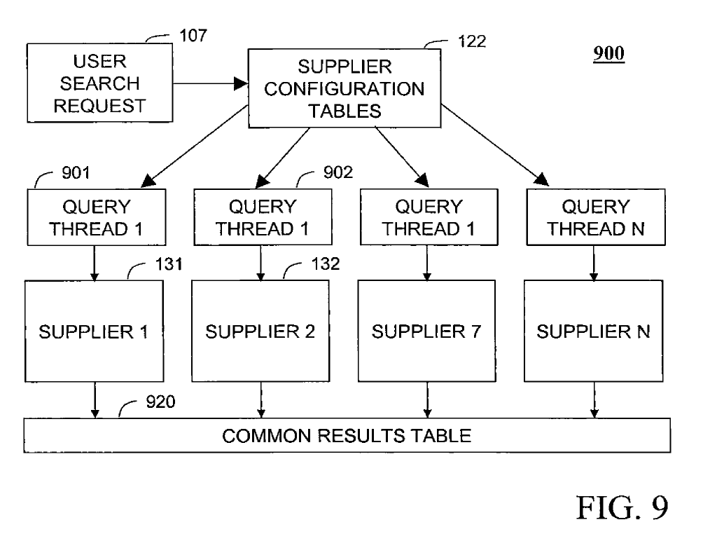

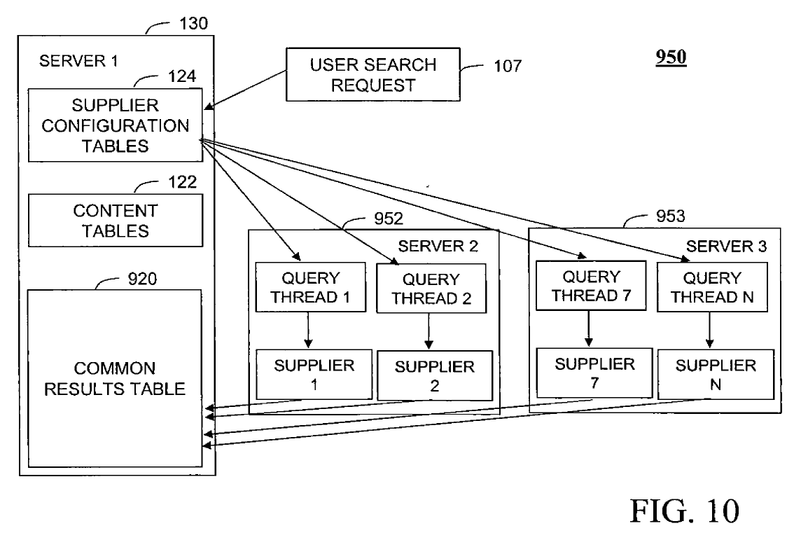

Referring to FIG. 10, a computing architecture 900 for conducting the search is shown. The computing architecture 900 increases an efficiency of the search by allowing for a threaded and parallel search. The computing architecture 900 increases a product scalability of the e-catalog system with limited reduction on user performance. For example, an increased number of products can be listed without adversely affecting the search time for the products. In particular, an independent thread of execution can be created for each configuration query. That is, a search request 107 corresponding to a first supplier configuration query can be conducted independently from other supplier configuration queries. For example, referring to FIG. 1, the server 130 can spawn a thread of execution for each supplier configuration query in FIG. 9. A first query thread 901 can be spawned for supplier configuration query 811 of Supplier 1 (131), a second query thread 902 can be spawned for supplier configuration query 812 of Supplier 2 (132), and so on. Each thread can be a supplier configuration query that performs a single fetch into a supplier content table. The threads can be executed in parallel to produce one or more query results.

Notably, the supplier content tables are arranged within the content tables 122 in a highly de-normalized structure. Accordingly, the threaded supplier configuration queries (901-902) are optimized for a single fetch based on the parameters passed to supplier configuration queries from the configuration table 124. The parameters identify the categories within a supplier table that can be searched. Notably, a supplier configuration query can be generated for each supplier query. Understandably, all threaded supplier configuration queries can be executed in parallel based on the computing architecture shown in FIG. 10. The results from each query can be placed in a common results table 920 in a common format. For example, each query may return a list of results in different formats. The common results table 920 can arrange the data in a consistent format for display by the server 130. For example, the server (See FIG. 1) can display the results from each query in a standard table, or file, having a common format. The server 130 can sort the one or more query results in the common results table 920. Notably, a high searches are made possible through the threaded and parallel computing architecture of FIG. 10. The computing architecture 100 also allows for multiple user searches which increases a scalability of users to employ the e-catalog system 100.

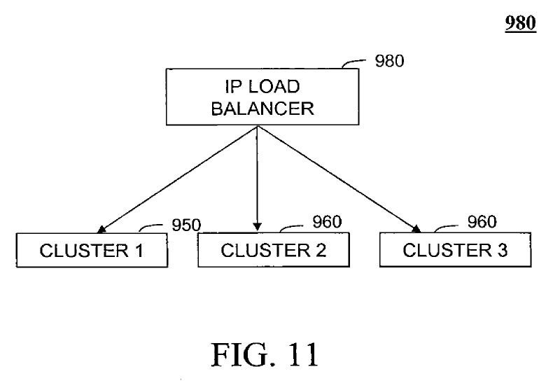

Moreover, the scalability of the e-catalog system 100 can be increased by balancing the search over multiple servers. Referring to FIG. 11, a multiple server configuration 950 is shown for increasing a search performance. The server configuration 950 can assign one or more servers (952-953) to handle independent threads of execution. The server 130 can process the search request 107 and generate the one or more supplier configuration queries. The first server 130 can include the configuration table 124 and the supplier content tables 122 for generating the supplier configuration queries. The server 130 can then spawn a thread for each supplier configuration query. Notably the supplier configuration query may contain data that is presented by value or reference. For example, a query thread operating on a second server (952) may retrieve data from the first server (130) to process the search request. Alternatively, the server 130 may allocate supplier content tables to various servers (952, 953) for specifically searching those supplier content tables. For example, server 952 may contain content tables for Supplier 1 and Supplier 2. Server 953, may contain content tables for Supplier 7. Notably, server 952 can process query threads corresponding to searches within content tables of Supplier 1 and 2. Server 953 can process query threads corresponding to searches within content tables of Supplier 7. In particular, each query thread can be directed to an appropriate processor for execution. The results of each query thread, though executed in parallel, can be provided to the common results table 920 which may be on the first server 130. Secondary sorting of the results can take place in the common results table 20 without a main query being re-run.

Referring to FIG. 11, an Internet protocol (IP) load balancer 980 employing clustering is shown. The IP load balancer 980 can support one or more clusters (950, 960, and 970) for balancing a processing load. Understandably, more or less than the number of clusters shown is herein contemplated. The diagram of FIG. 11 presenting 3 clusters is shown merely for illustration. Such a distributed processing arrangement allows for an increased scaling in the number of users to the e-catalog system (100). In particular, each cluster 950 managed by the IP load balancer represents the threaded and parallel computing shown in FIG. 10. For example, each cluster 950 can consist of multiple servers (130, 952, 953) executing threaded supplier configuration queries in parallel. The IP load balancing system 980 expands the e-catalog system over a distributed network to support an increased number of users. Notably, the IP load balancing system 980 can identify supplier configuration queries directed to the same application clusters. For example, the IP load balancing system can identify users issuing search requests returning to the same application cluster and ensure the users are directed to the same application cluster. In the case of an application cluster failure, the IP load balancer 970 can redirect the search requests to one of the remaining application clusters.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A system for searching a database, comprising:
at least one content table having a de-normalized structure, wherein data in the at least one content table is organized by category;
a configuration table for dynamically managing content of the at least one content table and generating at least one configuration query into the at least one content table; and
a search engine for conducting a search in at least one category of the at least one content table and retrieving data from the at least one category in a single fetch using the at least one configuration query,
wherein the at least one configuration query identifies at least one category in the at least one content table that is searched by the search engine in one fetch.

2. The system of claim 1, further comprising:
a customer input module for specifying a search request and determining a customer identify,
wherein the configuration table tracks a supplier, a view, and at least one price structure for the one or more content tables to configure the content at a customer node level based on the customer identify.

3. The system of claim 1, further comprising:
a data loader and scrubber for populating the configuration table; and
a threading module for executing at least one configuration query in parallel.

4. The system of claim 3, further comprising:
a load balancer for distributing and redirecting the executing across one or more application clusters.

5. A method for searching content in a de-normalized database, comprising:
receiving a search request from a user;
constructing a configuration query from a configuration table based on an identity of the user; and
executing a single fetch into a content table using the configuration query to retrieve content from the content table,
wherein the configuration query identifies a search for at least one pricing structure based on the identity of the user.

6. The method of claim 5, further comprising:
determining a user view associated with the search request; and
including the user view with the configuration query for narrowing a search in the supplier content table.

7. The method of claim 5, wherein the executing a single fetch into a content table is performed by a relational database search engine.

8. The method of claim 7, further comprising:
assigning a unique identifier to the user view; and
adding the unique identifier to a view structure in the content table,
wherein the relational database search engine associates the unique identifier with a configuration for retrieving content from the one or more content tables.

9. The method of claim 8, further comprising:
separating one or more unique identifiers by a space for stemming a data query in the one or more content tables.

10. The method of claim 5, further comprising:
determining a number of buyers and suppliers; and
generating one or more supplier configuration queries based on the number of suppliers available to the buyers.

11. The method of claim 5, further comprising:
generating at least one thread for the at least one configuration query;
executing the at least one thread in parallel to produce at least one query result; and
presenting the at least one query result to a common results table;
wherein the at least one query result is presented in a common format in the common results table.

12. The method of claim 11, further comprising:
sorting the at least one query result in the common table.

13. The method of claim 11, further comprising:
balancing a loading of the threads over at least one server to provide scalability for hosting multiple products,
wherein the at least one thread is executed independently in the at least one server.

14. The method of claim 13, further comprising:
clustering common search requests to provide scalability for supporting multiple users.

15. A method for creating a configuration table, comprising:
identifying at least one supplier having at least one content file, wherein the at least one content file describes supplies provided by the at least one supplier;
generating a supplier content table having a de-normalized structure from the at least one content file for the at least one supplier,
identifying a buyer of the supplies listed in the at least one content file;
generating a supplier configuration for the buyer that matches a pricing structure of the buyer in the supplier content table based on an identity of the buyer; and
loading the supplier configuration in the supplier configuration table.

16. The method of claim 15, further comprising:
determining at least one supplier available to the buyer;
generating a supplier content table for each additional supplier;
generating a supplier configuration for each additional supplier based on the buyer's access to one or more pricing structures in the supplier content table; and
updating the configuration table by loading the supplier configuration for each additional supplier into the supplier configuration table,
wherein a supplier configuration identifies structures in a supplier content table are available to search by a buyer.

17. The method of claim 15, further comprising dynamically adding one more structure to the content table for expanding a supplier offering.

18. The method of claim 15, further comprising:
determining a view associated with the buyer; and
entering the view in a view structure in the supplier content table,
wherein the view identifies at least one entry in at least one structure of the supplier content table that is available for search to the buyer.

19. The method of claim 15, wherein generating a supplier content table comprises:
denormaling a relational database model of the at least one content file to generate a column structured table;
wherein the denormalizing includes converting at least one relational table in the relational database model into columns in the column structured table, wherein the at least one relational table represents the at least one content file.

20. The method of claim 19, wherein the supplier configuration is a column formatted table having a content column, a price column, or a view column, wherein the columns are the structures of the supplier content table.
